(19) United States
(12) Patent Application Publication
(10) Pub. No.: US 2015/0073779 A1
(43) Pub. Date: Mar. 12, 2015

(54) METHOD OF CONVERTING USER HANDWRITING INTO TEXT INFORMATION AND ELECTRONIC DEVICE FOR PERFORMING THE SAME

(71) Applicant: Samsung Electronics Co., Ltd., Gyeonggi-do (KR)

(72) Inventors: Hee-bum AHN, Seoul (KR); Do-hyeon Kim, Gyeonggi-do (KR); Ho-young Jung, Gyeonggi-do (KR); Seong-taek Hwang, Gyeonggi-do (KR)

(73) Assignee: Samsung Electronics Co., Ltd.

(21) Appl. No.: 14/479,902

(22) Filed: Sep. 8, 2014

(30) Foreign Application Priority Data
Sep. 6, 2013 (KR) 10-2013-0107504

(51) Int. Cl. G06K 9/00; G06F 3/0481

(52) U.S. Cl. CPC G06K 9/00422; G06F 3/0481
USPC 704/9

(57) ABSTRACT

A method, computer-readable storage medium, and device for converting user handwriting into text information by reflecting a paragraph form of the user handwriting in an electronic device is provided. The method includes receiving a handwriting input from a user, recognizing the received handwriting input and converting the recognized handwriting input into text information, recognizing a paragraph form of the received handwriting input, and applying the recognized paragraph form to the converted text information.

### PRIORITY

This application claims priority under 35 U.S.C. §119(a) to a Korean Patent Application filed on Sep. 6, 2013 in the Korean Intellectual Property Office and assigned Serial No. 10-2013-0107504, the entire contents of which are incorporated herein by reference.

### BACKGROUND

1. Field of the Invention

The present invention generally relates to a method of and electronic device for converting user handwriting into text information.

2. Description of the Related Art

In the related art, an input is applied to an electronic device by using an input device such as a keyboard or a mouse. However, since a user is used to writing letters on paper, a user unskilled with an input device such as a keyboard or a mouse may find it difficult to use an input device such as a keyboard or a mouse. Also, users skilled at using an input device desire to easily apply the input device to writing letters. Due to current demand, a handwriting recognition method has been developed as an input method. That is, handwriting recognition is an input method that converts a signal, which is input to a touch screen of an electronic device by using an electronic pen or a stylus, into a digital signal. Through handwriting recognition, users easily write letters without having to learn another input method. In addition, as text conversion technology advances, a handwriting input converted into a digital signal may be converted into text information, and thus, handwriting may be input, and may be freely corrected and stored in an electronic device. However, in the related art, a handwriting input is converted into text information, but it is unable to analyze an input sentence and paragraph, determine what layout form an input sentence and paragraph are arranged in, and provide such a determination. Also, the related art is unable to define an entity such as a date form and recognize a corresponding handwriting input to convert the handwriting input into a predetermined form.

### SUMMARY

The present invention has been made to address the above problems and disadvantages and to provide at least the advantages described below. Accordingly, an aspect of the present invention is to provide a method of converting user handwriting into text information and an electronic device for performing the same.

In accordance with an aspect of the present invention, a method of converting user handwriting into text information by reflecting a paragraph form of the user handwriting in an electronic device is provided. The method includes receiving a handwriting input from a user; recognizing the received handwriting input and converting the recognized handwriting input into text information; recognizing a paragraph form of the received handwriting input; and applying the recognized paragraph form to the converted text information.

In accordance with another aspect of the present invention, a non-transitory computer-readable storage medium having recorded thereon a computer program for executing a method of converting user handwriting into text information by reflecting a paragraph form of the user handwriting in an electronic device is provided. The method executed by the computer program of the non-transitory computer-readable storage medium includes receiving a handwriting input from a user; recognizing the received handwriting input and converting the recognized handwriting input into text information; recognizing a paragraph form of the received handwriting input; and applying the recognized paragraph form to the converted text information.

In accordance with another aspect of the present invention, an electronic device is provided. The electronic device includes a user handwriting input receiving unit configured to receive a handwriting input from a user; a text information converting unit configured to recognize the received handwriting input and convert the recognized handwriting input into text information; a paragraph form recognizing unit configured to recognize a paragraph form of the received handwriting input; and a form applying unit configured to apply the recognized paragraph form to the converted text information.

### BRIEF DESCRIPTION OF THE DRAWINGS

The above and other aspects, features, and advantages of the present invention will be more apparent from the following detailed description, taken in conjunction with the accompanying drawings, in which:

FIG. 1 is a diagram of a method of converting user handwriting into text information by reflecting a paragraph form of the user handwriting in an electronic device according to an embodiment of the present invention;

FIG. 2 is a diagram of a method of converting between user handwriting and text information in which a form is reflected and displaying one of the user handwriting and the text information according to an embodiment of the present invention;

FIG. 3 is a diagram illustrating a method of converting user handwriting into text information by reflecting a paragraph form of the user handwriting in an electronic device according to an embodiment of the present invention;

FIG. 4 is a flowchart illustrating a method of converting user handwriting into text information by reflecting a paragraph form of the user handwriting, in an electronic device according to an embodiment of the present invention;

FIG. 5 is a flowchart illustrating a method of converting user handwriting into text information by reflecting a paragraph form of the user handwriting, in an electronic device according to an embodiment of the present invention;

FIG. 6 is a flowchart illustrating a method of converting user handwriting into text information by reflecting a paragraph form of the user handwriting, in an electronic device according to an embodiment of the present invention;

FIG. 7 is a flowchart illustrating a method of converting user handwriting into text information by reflecting a paragraph form of the user handwriting, in an electronic device according to an embodiment of the present invention;

FIG. 8 is a flowchart illustrating a method of converting user handwriting into text information by reflecting a paragraph form of the user handwriting, in an electronic device according to an embodiment of the present invention;

FIG. 9 is a flowchart illustrating a method of converting user handwriting into text information by reflecting a paragraph form of the user handwriting, in an electronic device according to an embodiment of the present invention; and

FIG. 10 is a diagram illustrating an electronic device for converting user handwriting into text information by reflecting a paragraph form of the user handwriting, according to an embodiment of the present invention.

### DETAILED DESCRIPTION OF EMBODIMENTS OF THE PRESENT INVENTION

Reference will now be made in detail to embodiments of the present invention, which are illustrated in the accompanying drawings, wherein like reference numerals refer to like elements throughout. In this regard, the embodiments of the present invention may have different forms and should not be construed as being limited to the descriptions set forth herein. Accordingly, the embodiments of the present invention are described below, by referring to the figures, to explain aspects of the present invention.

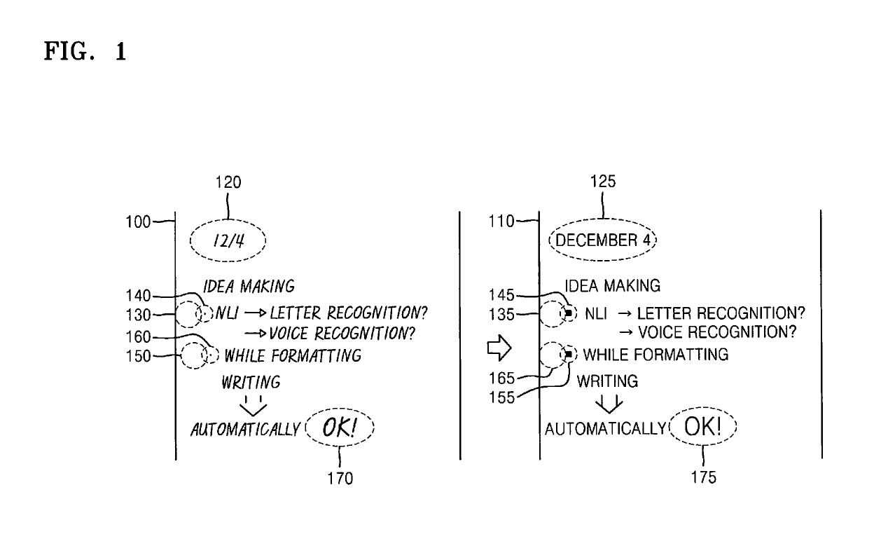

FIG. 1 is a diagram of a method of converting user handwriting into text information by reflecting a paragraph form of the user handwriting, in an electronic device according to an embodiment of the present invention.

Referring to FIG. 1, user handwriting 100 and a converted text 110 are illustrated.

The user handwriting 100 includes a date 120, a space 130, a sign 140, a space 150, a sign 160, and an emphasis syntax 170.

In the embodiment of the present invention, it is assumed that a setting that allows a date form such as “*/#” to be converted into “* month # day” is previously made by a user.

Therefore, in the embodiment of the present invention, a date 120 written as ‘12/4’ is converted into ‘December 4’, and is expressed as a converted date 125 in a converted text 110.

Here, a date is an example of an entity, and the present invention is not limited thereto. There may be various entities such as a place name, a name, and a place. The entity denotes a type which is previously designated by a user, and when information corresponding to an entity is previously set by the user and the entity is recognized, the electronic device applies information, corresponding to the entity, to text information.

According to the embodiment of the present invention, in the user handwriting 100, there is no separate figure before the “IDEA MAKING” portion, and the sign 140 exists before the “NLI->LETTER RECOGNITION?” portion. Also, unlike the “IDEA MAKING” portion, the “NLI->LETTER RECOGNITION?” portion includes the space 130. Therefore, in the embodiment of the present invention, the electronic device recognizes outline levels of two sentences differently. In detail, the electronic device recognizes the “IDEA MAKING” portion as a title, and recognizes the “NLI->LETTER RECOGNITION?” portion as a body text.

As a result, in the converted text 110, the indent 135 is applied to the “NLI->LETTER RECOGNITION?” portion unlike the “IDEA MAKING” portion.

The sign 140 exists before the “NLI->LETTER RECOGNITION?” portion. In the embodiment of the present invention, the electronic device determines a figure, which exists before the “NLI->LETTER RECOGNITION?” portion, as a sign for distinguishing one sentence from another sentence and recognizes the figure as a bullet. Similarly to the figure, the bullet denotes a sign which is used to distinguish one sentence from another sentence.

Therefore, in the embodiment of the present invention, a tetragonal bullet 145 predefined by the user is generated in correspondence with the sign 140, and is applied to the converted text 110. The bullet 145 applied to the converted text 110 is aligned with a letter with an interval therebetween.

In the present embodiment, the signs 140 and 160 having the same shape occur before the “NLI->LETTER RECOGNITION?” portion and “WHILE FORMATTING” portion. A size of the space 130 differs from that of the space 150, but the “NLI->LETTER RECOGNITION?” portion and the “WHILE FORMATTING” portion are recognized as having the same outline level (e.g. a body text level), based on a space being within an allowable range and the signs 140 and 160 having the same shape.

Therefore, in the converted text 110, a bullet 155 and indent 165 are applied before the “WHILE FORMATTING” portion. In this case, an interval between the bullet 155 and a letter maintains the same interval as that of the “NLI->LETTER RECOGNITION?” portion.

In the embodiment of the present invention, the “WRITING” portion and the “WHILE FORMATTING” portion are included in the same sentence. In the embodiment of the present invention, since there is no period in the “WHILE FORMATTING” portion, they are recognized as being in the same sentence, because no bullet was used. Therefore, since an outline level is recognized as the same outline level (e.g. a body text level), the “WRITING” portion is not aligned with the “WHILE FORMATTING” portion in the user handwriting 100, but the “WRITING” portion is aligned with the “WHILE FORMATTING” portion in the converted text 110.

In the present embodiment, the “OK!” portion 170 included in the user handwriting 100 has a larger size than that of a letter in another portion. The electronic device recognizes an average letter size, and recognizes that a letter size of an emphasis syntax 170 “OK!” is larger than an average letter size. Therefore, a font size of the emphasis syntax 170 “OK!” applied to the converted text 110 is larger than a font size of another portion in the converted text 110.

In the user handwriting 100, the “AUTOMATICALLY OK!” portion is not aligned with the “WHILE FORMATTING” portion, and there is no sign 160. However, there is an arrow between the “WRITING” portion and the “AUTOMATICALLY OK!” portion, and thus, the electronic device may recognize the “WHILE FORMATTING” portion and the “AUTOMATICALLY OK!” portion as content which have the same outline level.

Therefore, in the embodiment of the present invention, the “AUTOMATICALLY OK!” portion included in the converted text 110 is aligned with the “WHILE FORMATTING” portion.

As an example of a form applied to the embodiment of the present invention, indent, an outline level, and a font have been described, but are not limited thereto. As another example, various forms such as outdent, alignment, and line spacing may be applied.

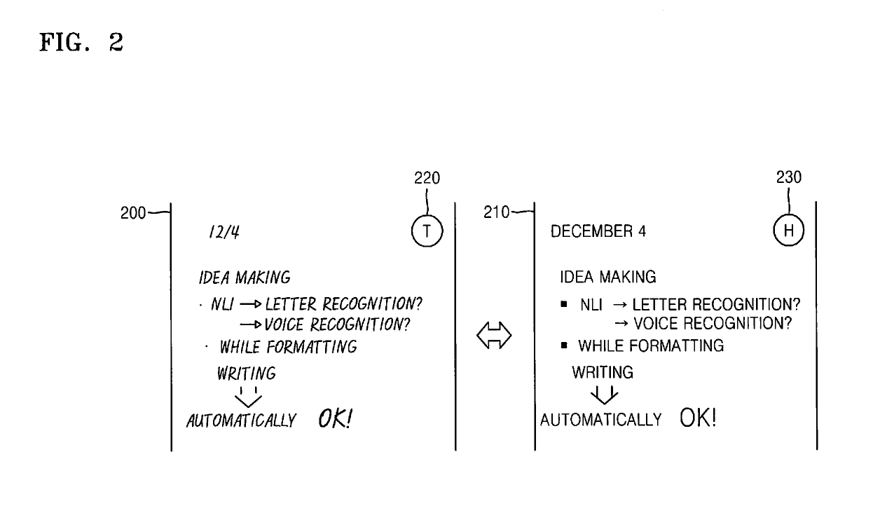

FIG. 2 is a diagram of a method of converting between the original and text information in which a form is reflected and displaying one of the handwriting and the text information, according to an embodiment of the present invention.

Referring to FIG. 2, user handwriting 200 and a converted text 210 are illustrated.

An electronic device displays at least one selected from the user handwriting 200 and the converted text 210. In the embodiment of the present invention, the user handwriting 200 or the converted text 210 is displayed.

When the user handwriting 200 is displayed in the electronic device, a text conversion button 220 is displayed at an upper right end along with the user handwriting 200. Then, when a user selects the text conversion button 220, the converted text 210 is displayed via conversion. In addition, when the converted text 210 is displayed in the electronic device, a handwriting conversion button 230 is displayed at a upper right end along with the converted text 210. Then, when the user selects the handwriting conversion button 230, the user handwriting 200 is displayed via conversion.

The text conversion button 220 and the handwriting conversion button 230 are displayed when the user handwriting 200 and the converted text 210 are stored in the electronic device.

However, the present invention is not limited thereto. The user handwriting 200 and the converted text 210 may be simultaneously displayed in the electronic device, and thus, the user may compare the user handwriting 200 with the converted text 210.

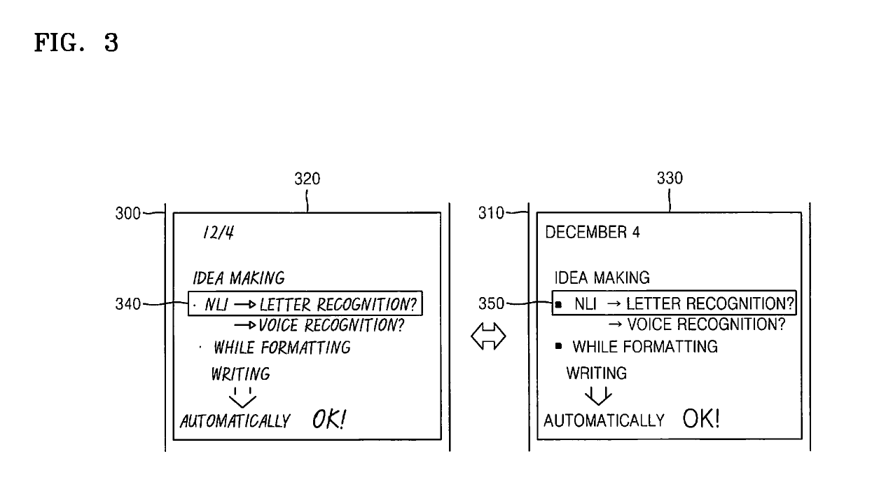

FIG. 3 is a diagram illustrating a method of converting user handwriting into text information by reflecting a paragraph form of the user handwriting, in an electronic device according to an embodiment of the present invention.

Referring to FIG. 3, the electronic device sets an entire writing range region 320 in a user handwriting 300. The electronic device receives an input, which selects a Region Of Interest (ROI) in the user handwriting 300, from a user, and determines the ROI as the entire writing range region 320.

The electronic device recognizes a size of a letter font included in the entire writing range region 320. An average letter size is set by analyzing a letter size. In detail, an average size of letters included in a handwriting input is calculated, letters having a size within a predetermined range from the calculated average size are recognized as having a size of a font corresponding to an average size, and letters having a size exceeding a range from the calculated average size are recognized as having a larger font size than an average size.

Moreover, the electronic device recognizes a paragraph form candidate group in the entire writing range region 320.

For example, the paragraph form candidate group includes content, in which the “WRITING” portion and the “WHILE FORMATTING” portion have the same outline level, and content in which the “WRITING” portion and the “WHILE FORMATTING” portion have different outline levels.

The electronic device determines, as a sentence region 340, a region in which a sentence included in the user input handwriting exists. In detail, the electronic device determines the sentence region, based on handwriting coordinates. Here, the handwriting coordinates denote vertex coordinates of a tetragonal region including letters. The electronic device recognizes, as a paragraph form, at least one paragraph form of the paragraph form candidate group in the sentence region 340. For example, the “WRITING” portion and the “WHILE FORMATTING” portion may be included in one sentence, and may be determined as one sentence region 30. In this case, since the “WRITING” portion and the “WHILE FORMATTING” portion are included in one sentence, the electronic device recognizes, as a paragraph form, content in which the “WRITING” portion and the “WHILE FORMATTING” portion in the paragraph form candidate group have the same outline level.

In the converted text 310, the electronic device applies a recognized average letter size to the entire writing range region 330. In detail, an average size of letters included in a handwriting input is calculated, letters having a size within a predetermined range from the calculated average size are recognized as having a font size corresponding to an average size, and letters having a size exceeding a range from the calculated average size are recognized as having a larger font size than an average size.

The electronic device determines a sentence region 350 in the converted text 310, based on handwriting coordinates. Rearrangement and readjustment of a region is performed within an allowable value in consideration of the whole arrangement, based on a paragraph form recognized in the user handwriting 300. In this case, the rearrangement denotes that a region is moved in a front direction, a rear direction, a left direction, or a right direction, and the readjustment denotes that a range of a region is reduced, enlarged, or rotated.

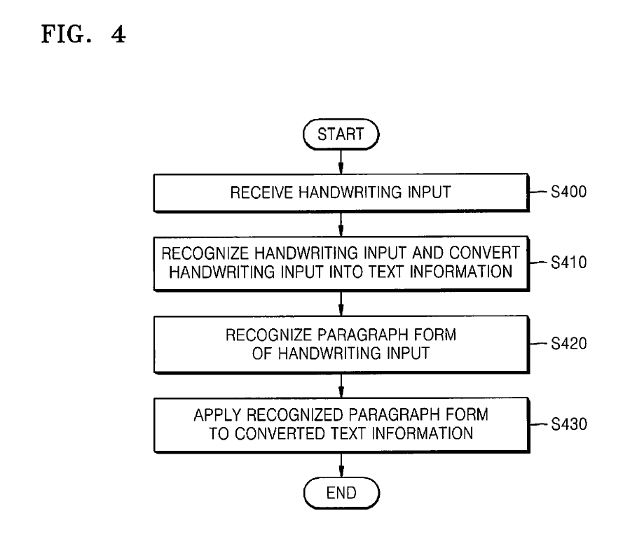

FIG. 4 is a flowchart illustrating a method of converting user handwriting into text information by reflecting a paragraph form of the user handwriting, in an electronic device according to an embodiment of the present invention.

In step S400, the electronic device receives a handwriting input. The handwriting input may be an input that is applied by an electronic writing tool such as an electronic pen or a stylus, but the present invention is not limited thereto. For example, an input may be applied by various electronic writing means, and the electronic device may receive an input that is applied by the electronic writing means.

In step S410, the electronic device recognizes the handwriting input, and converts the handwriting input into text information. The converted text information is information that includes a special letter, a sign, and a digit, in addition to a text.

In step S420, the electronic device recognizes a paragraph form of the handwriting input. Here, the paragraph form includes a paragraph shape, a font, and a bullet. The paragraph shape includes at least one selected from indent, outdent, word spacing, alignment, line spacing, and an outline level. In this case, the indent denotes that letters are written in a state where one space is left at a left letter head of a paragraph, for indicating the start of a new sentence. In contrast, the outdent denotes that letters in one row are written to protrude more leftwards than other rows. The word spacing denotes the spacing between words. The alignment denotes that letters within a range are evenly aligned according to a reference like right alignment and left alignment. The line spacing denotes an interval between lines. The outline level denotes that handwriting is divided into overall outline levels such as a title and a body text, and that a level is set. For example, the title may be a first level, and the body text may be a second level. The font denotes one set including capital letters, small letters, punctuations, and digits such as having the same writing style in a syntax type. For example, a 10-point Korean font GungSe style may be one font. The bullet denotes a shape or a sign, which distinguishes a sentence or a paragraph. For example, the bullet may be a tetragonal black figure which is added for distinguishing a sentence.

In Step S430, the electronic device applies the recognized paragraph form to the converted text information.

Referring to FIG. 1, when the recognized paragraph form is a shape of a paragraph, the electronic device recognizes the indents 135 and 165 from the spaces 130 and 150, and applies the indents 135 and 165. Signs 140 and 160 disposed in front of a sentence may be recognized, and may be applied as the bullets 145 and 155 in the converted text 110. When the bullets 145 and 155 are applied, letters may be aligned with an interval between the letters and the bullets 145 and 155. Also, letters having a size within a predetermined range from an average size calculated from the user handwriting 100 are recognized as having a size of a font corresponding to an average size, and the “OK!” emphasis syntax 170 having a size exceeding the predetermined range is recognized as having a larger font size than a font size corresponding to the average size.

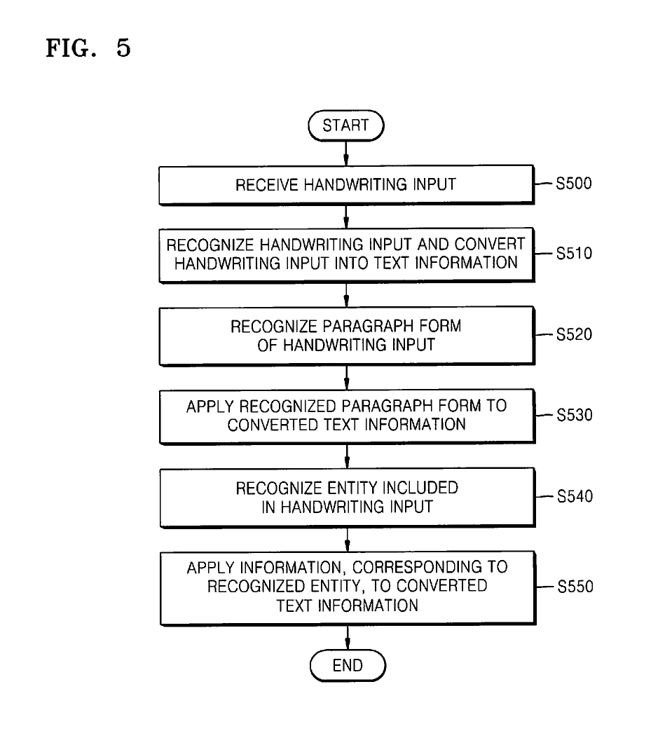

FIG. 5 is a flowchart illustrating a method of converting a user handwriting into text information by reflecting a paragraph form of the user handwriting, in an electronic device according to an embodiment of the present invention.

Steps S500 to S530 correspond to steps S400 to S430 of FIG. 4, and thus, their detailed descriptions are not provided.

In step S540, the electronic device recognizes an entity included in a handwriting input. Here, the entity denotes a type which is predefined by a user.

In step S550, the electronic device applies information, corresponding to the recognized entity, to the converted text information. The information corresponding to the recognized entity is previously set by the user. Referring to FIG. 1, when an entity such as the date 120 included in the user handwriting 100 is recognized, a converted date 125 that is the information corresponding to the recognized entity is applied to the converted text 110 and expressed. However, the present invention is not limited to the date, and information corresponding to various entities may be applied to text information.

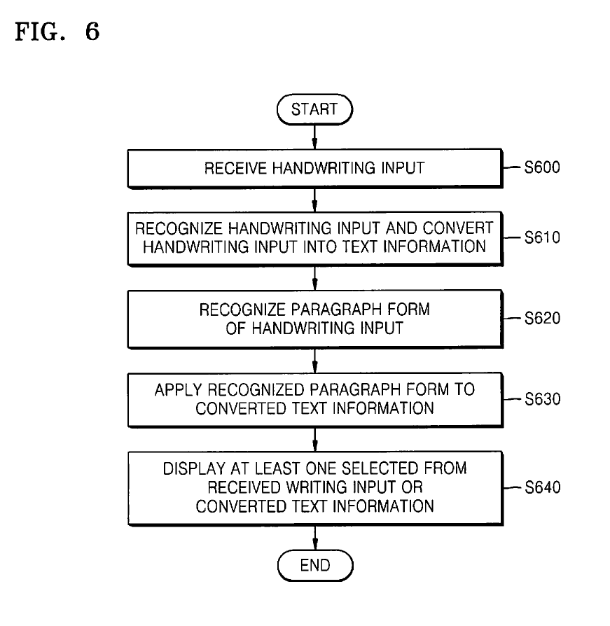

FIG. 6 is a flowchart illustrating a method of converting user handwriting into text information by reflecting a paragraph form of the user handwriting, in an electronic device according to an embodiment of the present invention.

Steps S600 to S630 correspond to steps S400 to S430 of FIG. 4, and thus, their detailed descriptions are not provided.

In step S640, the electronic device displays at least one selected from the received handwriting input or the converted text information. Generally, the converted text information is displayed, but the present invention is not limited thereto. The received handwriting input may also be displayed for checking whether the paragraph form is applied to the converted text. The received handwriting input and the converted text information may be simultaneously displayed in order for the user to easily check whether the paragraph form is applied.

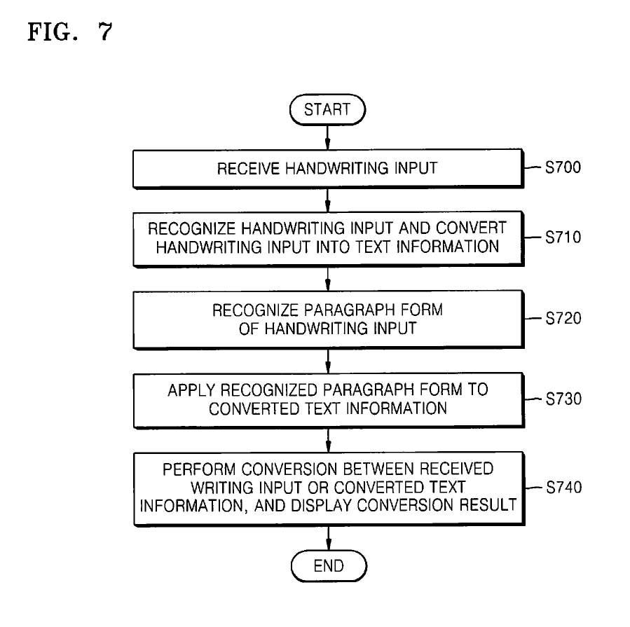

FIG. 7 is a flowchart illustrating a method of converting user handwriting into text information by reflecting a paragraph form of the user handwriting, in an electronic device according to an embodiment of the present invention.

Steps S700 to S730 correspond to operations S400 to S430 of FIG. 4, and thus, their detailed descriptions are not provided.

Referring to FIG. 7, in step S740, the received handwriting input or the converted text information are converted therebetween and displayed. The received handwriting input and the converted text information are stored before the received handwriting input or the converted text information is converted therebetween and displayed. The stored handwriting input and text information are converted therebetween and displayed according to the user's request. Referring to FIG. 2, the text conversion button 220 and the handwriting conversion button 230 are displayed, and the user may select the text conversion button 220 and the handwriting conversion button 230 to input the user's request.

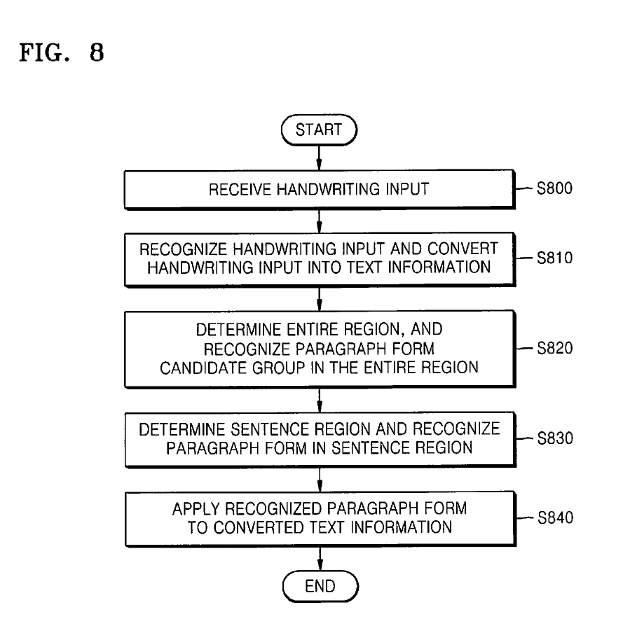

FIG. 8 is a flowchart illustrating a method of converting user handwriting into text information by reflecting a paragraph form of the user handwriting, in an electronic device according to an embodiment of the present invention.

Steps S800, S810, and S840 correspond to steps S400, S410, and S430 of FIG. 4, and thus, their detailed descriptions are not provided.

In step S820, the electronic device determines an entire region, and recognizes a paragraph form candidate group in the entire region.

For example, referring to FIG. 3, the paragraph form candidate group in the entire region includes content, in which the “WRITING” portion and the “WHILE FORMATTING” portion have the same outline level, and content in which the “WRITING” portion and the “WHILE FORMATTING” portion have different outline levels.

In step S830 in FIG. 8, the electronic device determines, as a sentence region, a region in which a sentence included in the entire region exists, and recognizes, as a paragraph form, at least one paragraph form of the paragraph form candidate group in the sentence region. For example, referring to FIG. 3, the “WRITING” portion and the “WHILE FORMATTING” portion are included in one sentence, and are determined as one sentence region. In this case, since the “WRITING” portion and the “WHILE FORMATTING” portion are included in one sentence, the electronic device recognizes, as a paragraph form, content in which the “WRITING” portion and the “WHILE FORMATTING” portion in the paragraph form candidate group have the same outline level.

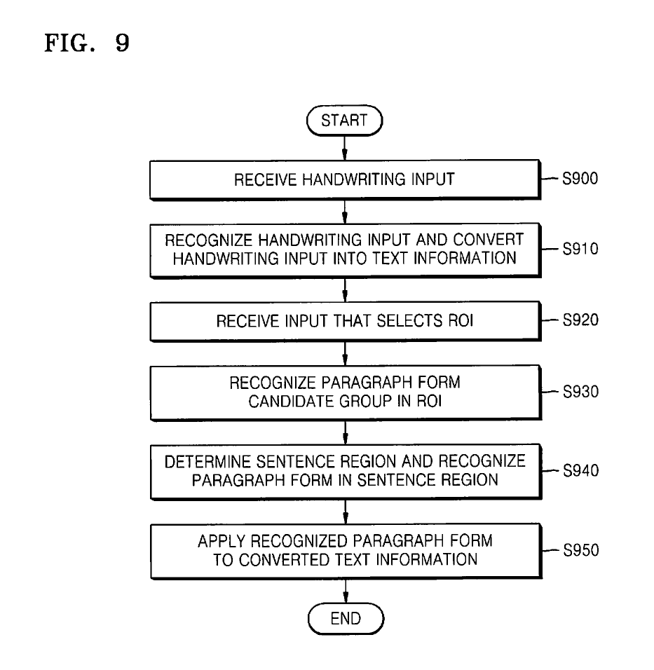

FIG. 9 is a flowchart illustrating a method of converting user handwriting into text information by reflecting a paragraph form of the user handwriting, in an electronic device according to an embodiment of the present invention.

Steps S900 and S910 correspond to steps S800 and S810 of FIG. 4, and thus, their detailed descriptions are not provided.

In step S920, the electronic device receives an input that selects an ROI from the user. In detail, the user applies an input by making a motion such as drawing a circle in a region in a touch interface included in the electronic device by using an electronic writing tool such as an electronic pen.

When the entire region in steps S820 to S840 of FIG. 8 is analyzed as an ROI, steps S930 to S950 correspond to steps S820 to S840, and thus, their detailed descriptions are not provided.

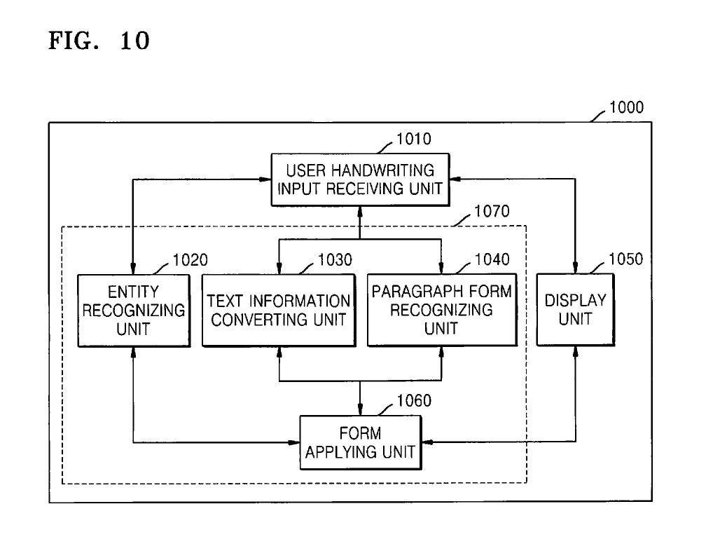

FIG. 10 is a diagram illustrating a configuration of an electronic device 1000 for converting user handwriting into text information by reflecting a paragraph form of the user handwriting, according to an embodiment of the present invention.

Referring to FIG. 10, the electronic device 1000 includes a user handwriting input receiving unit 1010, an entity recognizing unit 1020, a text information converting unit 1030, a paragraph form recognizing unit 1040, a display unit 1050, and a form applying unit 1060.

The user handwriting input receiving unit 1010 receives a handwriting input from a user. The user may input handwriting by using an electronic writing tool such as an electronic pen and a stylus. In detail, the electronic device 1000 may receive the handwriting input through a touch interface included in the electronic device 1000.

The text information converting unit 1030 recognizes the handwriting input received by the user handwriting input receiving unit 1010, and converts the handwriting input into text information. Text information converting unit 1030 may use various text information converting technologies.

The entity recognizing unit 1020 receives an entity included in the handwriting input received by the user handwriting input receiving unit 1010. In this case, the entity denotes a type which was previously designated by the user, and when information corresponding to an entity is previously set by the user and the entity is recognized, the electronic device applies information, corresponding to the entity, to the text information. In this case, the entity includes various types, which are defined by the user, such as a date, a place name, a name, a place, and an abbreviation.

The paragraph form recognizing unit 1040 recognizes a paragraph form of the handwriting input received by the user handwriting input receiving unit 1010. In this case, the paragraph form includes a paragraph shape, a font, and a bullet.

In detail, the paragraph form includes the paragraph shape, and the paragraph form recognizing unit 1040 recognizes, as the paragraph shape, at least one selected from indent, outdent, word spacing, alignment, line spacing, and an outline level.

As another example, the paragraph form includes a font of a letter, the paragraph form recognizing unit 1040 calculates an average size of letters included in the handwriting input, letters having a size within a predetermined range from the calculated average size may be recognized as having a size of a font corresponding to the average size, and letters having a size exceeding a range from the calculated average size may be recognized as having a larger font size than an average size.

As another example, the paragraph form may include a paragraph form bullet, and the paragraph form recognizing unit 1040 recognizes a figure, which distinguishes a sentence or a paragraph, as a bullet.

The paragraph form recognizing unit 1040 determines, as an entire region, a region in which user input handwriting exists, and recognizes a paragraph form candidate group in the entire region. The paragraph form recognizing unit 1040 determines, as a sentence region, a region in which a sentence included in the user input handwriting exists, and recognizes, as a paragraph form, at least one paragraph form of the paragraph form candidate group in the sentence region.

The paragraph form recognizing unit 1040 receives an input, which selects an ROI in the user input handwriting, from the user to recognize a paragraph form candidate group in the ROI. The paragraph form recognizing unit 1040 determines, as a sentence region, a region in which a sentence included in the ROI exists, and recognizes, as a paragraph form, at least one paragraph form of the paragraph form candidate group in the sentence region.

The display unit 1050 displays, to the user, at least one selected from the handwriting input (received by the user handwriting input receiving unit 1010) and text information obtained through conversion by the text information converting unit 1030. However, the present invention is not limited thereto. The handwriting input received by the user handwriting input receiving unit 1010 and text information obtained through conversion by the text information converting unit 1030 may be stored in a storage unit (not shown), and may be converted therebetween and displayed according to the user's request. The user's request may be received by the user selecting a button which is displayed by the display unit 1050 along with the received writing input or the converted text information.

The form applying unit 1060 applies the paragraph form, recognized by the paragraph form recognizing unit 1040, to the text information obtained through conversion by the text information converting unit 1030. Also, the form applying unit 1060 applies information, which is predetermined in correspondence with an entity recognized by the entity recognizing unit 1020, to the text information obtained through conversion by the text information converting unit 1030.

The entity recognizing unit 1020, the text information converting unit 1030, the paragraph form recognizing unit 1040, and the form applying unit 1060 are separately illustrated, but may be integrated into one control unit 1070 to perform the functions.

As described above, according to the one or more of the above embodiments of the present invention, the electronic device automatically formalizes user handwriting by using a paragraph analysis function, and provides a user with convenience for writing and management of the user handwriting.

The above-described embodiments of the present invention may be written as computer programs and may be implemented in general-use digital computers that execute the programs using a non-transitory computer-readable recording medium.

Examples of the non-transitory computer-readable recording medium include magnetic storage media (e.g., ROM, floppy disks, hard disks, etc.), optical recording media (e.g., CD-ROMs, or DVDs), etc), and transmission media such as Internet transmission media.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims and their equivalents.

What is claimed is:

1. A method of converting user handwriting into text information by reflecting a paragraph form of the user handwriting in an electronic device, the method comprising:
receiving a handwriting input from a user;
recognizing the received handwriting input and converting the recognized handwriting input into text information;
recognizing a paragraph form of the received handwriting input; and
applying the recognized paragraph form to the converted text information.

2. The method of claim 1, wherein,
the paragraph form comprises a paragraph shape, and
recognizing the paragraph form comprises recognizing, as the paragraph shape, at least one selected from indent, outdent, word spacing, alignment, line spacing, and an outline level.

3. The method of claim 1, wherein,
the paragraph form comprises a font of a letter included in a paragraph, and
recognizing the paragraph form comprises:
calculating an average size of letters included in the handwriting input;
recognizing letters, having a size within a predetermined range from the calculated average size, as having a size of a font corresponding to the average size; and
recognizing letters, having a size exceeding a range from the calculated average size, as having a larger font size than the average size.

4. The method of claim 1, wherein,
the paragraph form comprises a bullet, and
recognizing the paragraph form comprises recognizing a figure, which distinguishes a sentence or a paragraph, as a bullet.

5. The method of claim 1, further comprising:
recognizing an entity included in the received handwriting input; and
applying information, which is predetermined in correspondence with the recognized entity, to the converted text information.

6. The method of claim 1, further comprising displaying at least one selected from the received handwriting input and the converted text information.

7. The method of claim 6, wherein displaying at least one selected from the received handwriting input and the converted text information comprises storing the received handwriting input and the converted text information, and converting therebetween according to a request of a user.

8. The method of claim 1, wherein recognizing the paragraph form of the received handwriting input comprises:
determining a region, in which the handwriting input exists, as an entire region to recognize a paragraph form candidate group in the entire region; and
determining a region, in which a sentence included in the handwriting input exists, as a sentence region to recognize, as a paragraph form, at least one paragraph form of the paragraph form candidate group in the sentence region.

9. The method of claim 1, wherein recognizing the paragraph form of the received handwriting input comprises:
receiving an input, which selects a Region Of Interest (ROI) in the handwriting input, from the user to recognize a paragraph form candidate group in the ROI; and
determining a region, in which a sentence included in the ROI exists, as a sentence region to recognize, as a paragraph form, at least one paragraph form of the paragraph form candidate group in the sentence region.

10. A non-transitory computer-readable storage medium having recorded thereon a computer program for executing a method of converting user handwriting into text information by reflecting a paragraph form of the user handwriting in an electronic device, the method comprising:
receiving a handwriting input from a user;
recognizing the received handwriting input and converting the recognized handwriting input into text information;
recognizing a paragraph form of the received handwriting input; and
applying the recognized paragraph form to the converted text information.

11. An electronic device comprising:
a user handwriting input receiving unit configured to receive a handwriting input from a user;
a text information converting unit configured to recognize the received handwriting input and convert the recognized handwriting input into text information;
a paragraph form recognizing unit configured to recognize a paragraph form of the received handwriting input; and
a form applying unit configured to apply the recognized paragraph form to the converted text information.

12. The electronic device of claim 11, wherein,
the paragraph form comprises a paragraph shape, and
the paragraph form recognizing unit is configured to recognize, as the paragraph shape, at least one selected from indent, outdent, word spacing, alignment, line spacing, and an outline level.

13. The electronic device of claim 11, wherein,
the paragraph form comprises a font of a letter included in a paragraph, and
the paragraph form recognizing unit calculates an average of letters included in the handwriting input, recognizes letters, having a size within a predetermined range from the calculated average, as having a size of a font corresponding to the average, and recognizes letters, having a size exceeding a range from the calculated average, as having a larger font size than an average size.

14. The electronic device of claim 11, wherein,
the paragraph form comprises a bullet, and
the paragraph form recognizing unit is configured to recognize a figure, which distinguishes a sentence or a paragraph, as a bullet.

15. The electronic device of claim 11, further comprising an entity recognizing unit configured to recognize an entity included in the received handwriting input,
wherein the form applying unit is configured to apply information, which is predetermined in correspondence with the recognized entity, to the converted text information.

16. The electronic device of claim 11, further comprising a display unit configured to display at least one selected from the received handwriting input and the converted text information.

17. The electronic device of claim 16, wherein the display unit is configured to store the received handwriting input and the converted text information, and convert therebetween according to a request of a user.

18. The electronic device of claim 11, wherein the paragraph form recognizing unit is configured to determine a region, in which the handwriting input exists, as an entire region to recognize a paragraph form candidate group in the entire region, and determine a region, in which a sentence included in the handwriting input exists, as a sentence region to recognize, as a paragraph form, at least one paragraph form of the paragraph form candidate group in the sentence region.

19. The electronic device of claim 11, wherein the paragraph form recognizing unit is configured to receive an input, which selects a Region Of Interest (ROI) in the handwriting input, from the user to recognize a paragraph form candidate group in the ROI, and determine a region, in which a sentence included in the ROI exists, as a sentence region to recognize, as a paragraph form, at least one paragraph form of the paragraph form candidate group in the sentence region.
